(19) United States
(12) Patent Application Publication
(10) Pub. No.: US 2024/0299978 A1
(43) Pub. Date: Sep. 12, 2024

(54) COIL COATING

(71) Applicant: ARMSTRONG WORLD INDUSTRIES, INC., Lancaster, PA (US)

(72) Inventors: Dhruv PATEL, Jackson, TN (US); Steven L. MASIA, Lancaster, PA (US)

(21) Appl. No.: 18/595,817

(22) Filed: Mar. 5, 2024

Related U.S. Application Data
(60) Provisional application No. 63/450,793, filed on Mar. 8, 2023.

(51) Int. Cl. B05D 7/00; B05D 1/30; C09D 167/00

(52) U.S. Cl. CPC B05D 7/574; B05D 1/305; C09D 167/00; B05D 2202/00; B05D 2301/00; B05D 2350/60; B05D 2508/00; B05D 2518/10

(57) ABSTRACT

Described herein is a coated article comprising a substrate, a coil coating applied to the substrate, the coil coating comprising a base coat layer formed from a base coat composition comprising polyester that is substantially free of silicon; a print coat layer formed from a print coat composition comprising siliconized polyester; and a top coat layer formed from a top coat composition comprising siliconized polyester.

### CROSS-REFERENCE TO RELATED APPLICATIONS

This application claims the benefit of U.S. Provisional Application No. 63/450,793, filed on Mar. 8, 2023. The disclosure of the above application is incorporated herein by reference.

### BACKGROUND

Coil coated articles are useful in an array of applications but certain safety and health concerns exist for such coatings with respect to the content of formaldehyde and chromium. However, previous attempts at creating coil coatings that address such health concerns result in coatings having either inferior aesthetic and/or mechanical performance. Therefore, the need exists for a new coil coating that overcomes such limitations.

### BRIEF SUMMARY

The present invention is directed to a coated article comprising a substrate; a coil coating applied to the substrate, the coil coating comprising: a base coat layer formed from a base coat composition comprising polyester that is substantially free of silicon; a print coat layer formed from a print coat composition comprising siliconized polyester; and a top coat layer formed from a top coat composition comprising siliconized polyester.

Other embodiments of the present invention include a coated article comprising a substrate; and a coil coating applied to the substrate, the coil coating comprising: a primer coat layer formed from a primer coat composition that is substantially free of chromium; a base coat layer formed from a base coat composition comprising an organic polymer; a print coat layer formed from a print coat composition comprising colorant and siliconized organic polymer; and a top coat layer formed from a top coat composition comprising silica and siliconized organic polymer.

Other embodiments of the present invention include a coated article comprising a first major exposed surface opposite a second major exposed surface, the coated article comprising: a substrate comprising an upper surface opposite a lower surface; a coil coating applied to the substrate, the coil coating having an upper surface opposite a lower surface and the coil coating comprising: a primer coat layer comprising an upper surface opposite a lower surface, the primer layer formed from a primer composition that is substantially free of chromium; a base coat layer comprising an upper surface opposite a lower surface, the base coat layer formed from a base coat composition comprising polyester that is substantially free of silicon; a print coat layer comprising an upper surface opposite a lower surface, the print coat layer formed from a print coat composition comprising siliconized polyester; and a top coat layer comprising an upper surface opposite a lower surface, the top coat layer formed from a top coat composition comprising siliconized polyester; and wherein the first major exposed surface of the coated article comprises the upper surface of the top coat layer.

Other embodiments of the present invention include a method of forming a coated article comprising: a) applying a wet-state primer coat composition comprising a liquid carrier to a substrate and drying the wet-state primer coat composition that is applied to the substrate such that the liquid carrier of the wet-state primer coat composition is evaporated resulting in a primer coat layer; b) applying a wet-state base coat composition comprising a liquid carrier to the primer coat layer and drying the wet-state base coat composition that is applied to the primer coat layer such that the liquid carrier of the wet-state base coat composition is evaporated resulting in a base coat layer; c) applying a wet-state print coat composition comprising a liquid carrier to the base coat layer and drying the wet-state print coat composition that is applied to the base coat layer such that the liquid carrier of the wet-state print coat composition is evaporated resulting in a print coat layer; d) applying a wet-state top coat composition comprising a liquid carrier to the print coat layer and drying the wet-state top coat composition that is applied to the print coat layer such that the liquid carrier of the wet-state top coat composition is evaporated resulting in a top coat layer; and wherein the wet-state base coat composition further comprises an organic polymer that is substantially free of silicon; wherein the wet-state print coat composition further comprises siliconized organic polymer; and wherein the wet-state top coat composition further comprises siliconized organic polymer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a portion of a coated substrate;

FIG. 2 is a cross-sectional view of the coated substrate according to the present invention, the cross-sectional view being along the II line set forth in FIG. 1;

FIG. 3 is diagram of a coil coating application process according to the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means+/−5% of the reference value. According to the present application, the term “substantially free” less than about 0.05 wt. % based on the total of the referenced value.

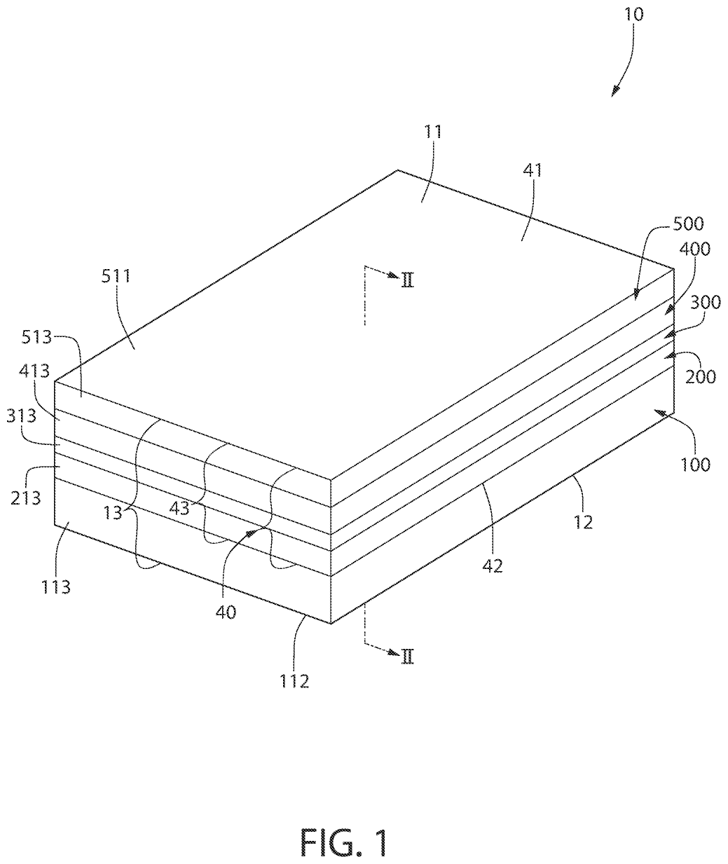

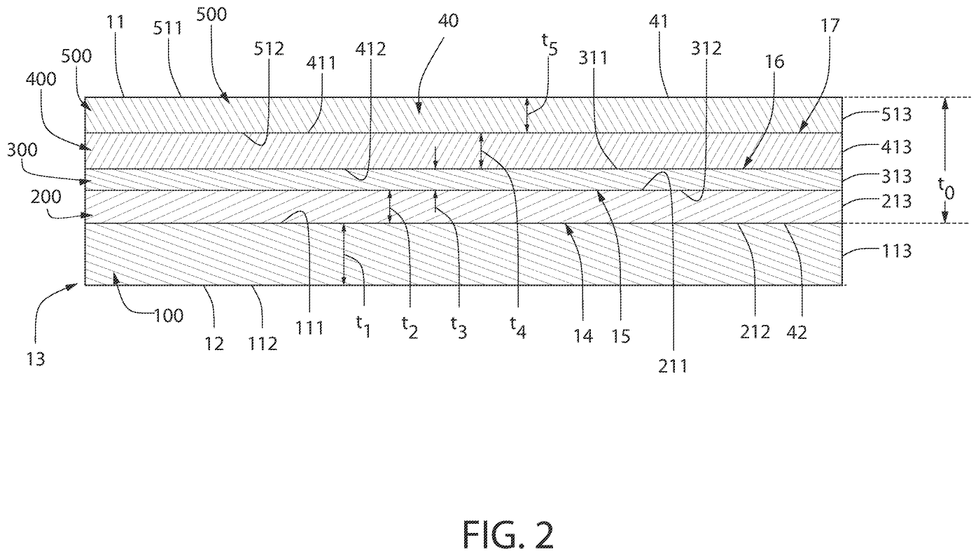

Referring to FIGS. 1 and 2, the present invention is directed to a coil coating 40. The coil coating 40 may comprise abase coat layer 300, a print coat layer 400, and a top coat layer 500. In some embodiments, the top coat layer 500 may also be referred to as the “clear coat layer” 500. The coil coating 40 may further comprise a primer coat layer 200.

The present invention may also be directed to a coated article 10 comprising the coil coating 40 as well as a substrate 100, whereby the coil coating 40 is applied to the substrate 100.

The coated article 10 may comprise a first major exposed surface 11 opposite a second major exposed surface 12. The coated article 10 may comprise a side exposed surface extending between the first major exposed surface 11 and the second major exposed surface 12.

Each of the primer coat layer 200, the base coat layer 300, the print coat layer 400, and the top coat layer 500 are discrete individual layers (may also be referred to as “sub-layers” of the coil coating 40). The term “discrete individual layers” refers to each of the primer coat layer 200, the base coat layer 300, the print coat layer 400, and the top coat layer 500 having an interface 14, 15, 16, and 17 defined between each of the adjacent most layers—as discussed in greater detail herein.

The coil coating 40 may comprise an upper surface 41 opposite a lower surface 42. The coil coating 40 may comprise a side surface 43 that extends between the upper surface 41 and the lower surface 42 of the coil coating 40. The coil coating 40 may have a coil coating thickness to as measured by the distance between the upper surface 41 and the lower surface 42 of the coil coating 40. The coil coating thickness to may range from about 1.5 mils to about 2.5 mils—including all thickness and sub-ranges there-between. In some embodiments, the coil coating thickness to may range from about 1.7 mils to about 2.1 mils—including all thickness and sub-ranges there-between.

The substrate 100 may comprise an upper surface 111 opposite a lower surface 112. The substrate 100 may comprise a side surface 113 that extends between the upper surface 111 and the lower surface 112 of the substrate 100. The substrate 100 may have a substrate thickness t₁ as measured by the distance between the upper surface 111 and the lower surface 112 of the substrate 100. The substrate thickness t₁ may range from about 1 mil to about 10 mils—including all thickness and sub-ranges there-between.

The primer coat layer 200 may comprise an upper surface 211 opposite a lower surface 212. The primer coat layer 200 may comprise a side surface 213 that extends between the upper surface 211 and the lower surface 212 of the primer coat layer 200. The primer coat layer 200 may have a primer coat thickness t₂ as measured by the distance between the upper surface 211 and the lower surface 212 of the primer coat layer 200. The primer coat thickness t₂ may range from about 0.5 mils to about 0.9 mils—including all thickness and sub-ranges there-between. In some embodiments, the primer coat thickness t₂ may range from about 0.6 mils to about 0.8 mils—including all thickness and sub-ranges there-between.

The base coat layer 300 may comprise an upper surface 311 opposite a lower surface 312. The base coat layer 300 may comprise a side surface 313 that extends between the upper surface 311 and the lower surface 312 of the base coat layer 300. The base coat layer 300 may have a base coat thickness t₃ as measured by the distance between the upper surface 311 and the lower surface 312 of the base coat layer 300. The base coat thickness t₃ may range from about 0.3 mils to about 0.9 mils—including all thickness and sub-ranges there-between. In some embodiments, the base coat thickness t₃ may range from about 0.7 mils to about 0.8 mils—including all thickness and sub-ranges there-between.

The print coat layer 400 may comprise an upper surface 411 opposite a lower surface 412. The print coat layer 400 may comprise a side surface 413 that extends between the upper surface 411 and the lower surface 412 of the print coat layer 400. The print coat layer 400 may have a print coat thickness t₄ as measured by the distance between the upper surface 411 and the lower surface 412 of the print coat layer 400. The print coat thickness t₄ may range from about 0.05 mils to about 0.15 mils—including all thickness and sub-ranges there-between. In some embodiments, the print coat thickness t₄ may be about 0.1 mils.

The top coat layer 500 may comprise an upper surface 511 opposite a lower surface 512. The top coat layer 500 may comprise a side surface 513 that extends between the upper surface 511 and the lower surface 512 of the top coat layer 500. The top coat layer 500 may have a top coat thickness t₅ as measured by the distance between the upper surface 511 and the lower surface 512 of the top coat layer 500. The top coat thickness t₅ may range from about 0.2 mils to about 0.6 mils—including all thickness and sub-ranges there-between. In some embodiments, the top coat thickness t₅ may range from about 0.3 mils to about 0.4 mils—including all thickness and sub-ranges there-between.

A ratio of the base thickness t₃ to the primer thickness t₂ may range from about 0.75:1 to about 1.45:1—including all ratios and sub-ranges there-between. In some embodiments, the ratio of the base thickness t₃ to the primer thickness t₂ may range from about 0.85:1 to about 1.35:1—including all ratios and sub-ranges there-between.

A ratio of the base thickness t₃ to the print thickness t₄ may range from about 6.5:1 to about 8.5:1—including all ratios and sub-ranges there-between. In some embodiments, the ratio of the base thickness t₃ to the print thickness t₄ may range from about 7:1 to about 8:1—including all ratios and sub-ranges there-between.

A ratio of the base thickness t₃ to the top thickness t₅ may range from about 1.5:1 to about 3.0:1—including all ratios and sub-ranges there-between. In some embodiments, the ratio of the base thickness t₃ to the top thickness t₅ may range from about 1.75:1 to about 2.7:1—including all ratios and sub-ranges there-between.

A ratio of the top thickness t₅ to the print thickness t₄ may range from about 2.5:1 to about 4.5:1—including all ratios and sub-ranges there-between. In some embodiments, the ratio of the top thickness t₅ to the print thickness t₄ may range from about 3:1 to about 4:1—including all ratios and sub-ranges there-between.

The upper surface 111 of the substrate 100 may be adjacent to the lower surface 212 of the primer coat layer 200. The upper surface 111 of the substrate 100 may contact the lower surface 212 of the primer coat layer 200. The upper surface 111 of the substrate 100 may directly contact the lower surface 212 of the primer coat layer 200. A first interface 14 may be located between the substrate 100 and the primer coat layer 200. The first interface 14 may be located between the upper surface 111 of the substrate 100 and the lower surface 212 of the primer coat layer 200. The first interface 14 may be formed by the contact between the upper surface 111 of the substrate 100 and the lower surface 212 of the primer coat layer 200.

The upper surface 211 of the primer coat layer 200 may be adjacent to the lower surface 312 of the base coat layer 300. The upper surface 211 of the primer coat layer 200 may contact the lower surface 312 of the base coat layer 300. The upper surface 211 of the primer coat layer 200 may directly contact the lower surface 312 of the base coat layer 300. A second interface 15 may be located between the primer coat layer 200 and the base coat layer 300. The second interface 15 may be located between the upper surface 211 of the primer coat layer 200 and the lower surface 312 of the base coat layer 300. The second interface 15 may be formed by the contact between the upper surface 211 of the primer coat layer 200 and the lower surface 312 of the base coat layer 300.

The upper surface 311 of the base coat layer 300 may be adjacent to the lower surface 412 of the print coat layer 400. The upper surface 311 of the base coat layer 300 may contact the lower surface 412 of the print coat layer 400. The upper surface 311 of the base coat layer 300 may directly contact the lower surface 412 of the print coat layer 400. A third interface 16 may be located between the base coat layer 300 and the print coat layer 400. The third interface 16 may be located between the upper surface 311 of the base coat layer 300 and the lower surface 412 of the print coat layer 400. The third interface 16 may be formed by the contact between the upper surface 311 of the base coat layer 300 and the lower surface 412 of the print coat layer 400.

The upper surface 411 of the print coat layer 400 may be adjacent to the lower surface 512 of the top coat layer 500. The upper surface 411 of the print coat layer 400 may contact the lower surface 512 of the top coat layer 500. The upper surface 411 of the print coat layer 400 may directly contact the lower surface 512 of the top coat layer 500. A fourth interface 17 may be located between the print coat layer 400 and the top coat layer 500. The fourth interface 17 may be located between the upper surface 411 of the print coat layer 400 and the lower surface 512 of the top coat layer 500. The fourth interface 17 may be formed by the contact between the upper surface 411 of the print coat layer 400 and the lower surface 512 of the top coat layer 500.

The first major exposed surface 11 of the coated article 10 may comprise the coil coating 40. The first major exposed surface 11 of the coated article 10 may comprise the upper surface 41 of the coil coating 40. The first major exposed surface 11 of the coated article 10 may comprise the top coat layer 500 of the coil coating 40. The first major exposed surface 11 of the coated article 10 may comprise the upper surface 511 of the top coat layer 500 of the coil coating 40.

The side exposed surface 13 of the coated article 10 may comprise the coil coating 40 and the substrate 100. The side exposed surface 13 of the coated article 10 may comprise the side surface 43 of the coil coating 40 and the side surface 113 of the substrate 100. The side surface 13 of the coated article 10 may comprise the substrate 100 as well as the primer coat layer 200, the base coat layer 300, the print coat layer 400, as well as the top coat layer 500. The side surface 13 of the coated article 10 may comprise the side surface 113 of the substrate 100 as well as the side surface 213 of the primer coat layer 200, the side surface 313 of the base coat layer 300, the side surface 413 of the print coat layer 400, as well as the side surface 513 of the top coat layer 500.

The second exposed major surface 12 of the coated article 10 may comprise the substrate 100. The second major exposed surface 12 of the coated article 10 may comprise the lower surface 112 of the substrate 100.

The primer coat layer 200 may be formed of a primer coat composition. The primer coat composition may be substantially free of chromium. In some embodiments, the primer coat composition may be free of chromium—i.e., the primer coat composition has a content of chromium that is 0.0 wt. % based on the total weight of the primer coat composition. The primer coat layer 200 may be formed of 100 wt. % of the primer coat composition based on the total weight of the primer coat layer 200.

The primer coat composition may be substantially free of polyvinylidene fluoride (“PVDF”). In some embodiments, the primer coat composition may be free of PVDF—i.e., the primer coat composition has a content of PVDF that is 0.0 wt. % based on the total weight of the primer coat composition. The primer coat layer 200 may be formed of 100 wt. % of the primer coat composition based on the total weight of the primer coat layer 200.

The primer coat composition of the primer coat layer 200 on the coil coating 40 may be in a solid state—i.e., the term “solid state” refers to a reference composition being substantially free of a liquid carrier. The primer coat composition of the primer coat layer 200 on the coil coating 40 may have a solids content of about 100 wt. % based on the total weight of the primer coat composition. The primer coat composition of the primer coat layer 100 on the coil coating 40 may have a solids content of about 100 wt. % based on the total weight of the primer coat layer 200 within the coil coating 40 on the coated article 10.

In some embodiments, the primer coat composition may be substantially free of silicon containing compounds. In some embodiments, the primer coat composition may be substantially free of silicon. In some embodiments, the primer coat composition may be substantially free of colorant.

The primer coat composition may comprise a polymer. The polymer may be an organic polymer. The polymer may be a polyester polymer. The polyester may be substantially free of silicon. The polymer may be a urethane modified polyester polymer. The urethane modified polyester polymer may be substantially free of silicon.

The polymer may be present in the primer coat composition in an amount ranging from about 60 wt. % to about 100 wt. % based on the total weight of the primer coat composition—including all wt. % and sub-ranges there-between.

The polyester polymer may be formed from the condensation reaction of a polycarboxylic acid and a polyol (e.g., diol, triol, etc.).

Non-limiting examples of polyester may be hydroxyl-functional (OH) or carboxyl-functional (COOH). The polyester resin may be the reaction product of a polycarboxylic acid and a polyol. For the purposes of this invention, the term polycarboxylic acid includes compounds having at least two carboxylic acid groups. For the purposes of this invention, the term polyol includes compounds having at least two hydroxyl groups.

For hydroxyl-functional polyester, the polyol is present relative to the polycarboxylic acid in an OH:COOH stoichiometric range of about 2:1 to about 6:1—including all ratios and sub-ranges there-between. When using an excess of polyol, such stoichiometric excess ensures that all free carboxylic acid groups are consumed while allowing excess hydroxyl groups to remain unconsumed during the esterification reaction. The hydroxyl groups may be present at the terminal ends of the polyester.

For carboxyl-functional polyester, the polycarboxylic acid is present relative to the polyol in a COOH:OH stoichiometric excess that ranges from 2:1 to 6:1. Excess polycarboxylic acid ensures that all free hydroxyl groups are consumed while allowing excess carboxylic acid groups to remain unconsumed during the esterification reaction. The carboxylic acid groups may be present at the terminal ends of the polyester.

The condensation reaction of hydroxyl-functional and carboxyl-functional compounds to form the polyester resin may be aided by a catalyst. In some non-limiting embodiments, the catalyst may be selected from N-methylimidazole, diazabicyclo[2,2,2]octane, diazabicyclo[5,4,0]undec-7-ene and pentamethyldiethylenetriamine and mixtures thereof. Other examples of suitable esterification catalyst include tetrabutyl-o-titanate, stannous octoate, p-toluene sulphonic acid, and combinations thereof.

In non-limiting embodiments, the polyol may be a diol, a triol, or a higher-functional polyol having 4-8 hydroxyl groups (e.g. tetrol). In some embodiments, the polyol may be aromatic, cycloaliphatic, aliphatic, or a combination thereof. In some embodiments, the carboxyl-functional compound is dicarboxylic acid, a tricarboxylic acid, a higher functional polycarboxylic acid having 4-8 carboxylic acid groups, or a combination thereof. In some embodiments, the polycarboxylic acid may be aliphatic, cycloaliphatic, aromatic, or a combination thereof.

Non-limiting examples of polyol may include a diol that is selected from alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; cyclohexanedimethanol; hexanediols including 1,6-hexanediol; hydroxy-alkylated bisphenols; polyether glycols, for example, poly(oxytetramethylene) glycol. In some embodiments, the polyol may be a triol or higher polyol that is selected from trimethylol propane, pentaerythritol, di-pentaerythritol, trimethylol ethane, trimethylol butane, dimethylol cyclohexane, glycerol and the like.

Non-limiting examples of polycarboxylic acid may include a dicarboxylic acid that is selected from adipic acid, azelaic acid, sebacic acid, succinic acid, glutaric acid, decanoic diacid, dodecanoic diacid, phthalic acid, isophthalic acid, 5-tert-butylisophthalic acid, tetrahydrophthalic acid, terephthalic acid, hexahydrophthalic acid, methylhexahydrophthalic acid, dimethyl terephthalate, 2,5-furandicarboxylic acid, 2,3-furandicarboxylic acid, 2,4-furandicarboxylic acid, 3,4-furandicarboxylic acid, 2,3,5-furantricarboxylic acid, 2,3,4,5-furantetracarboxylic acid, cyclohexane dicarboxylic acid, 1,3-cyclohexane dicarboxylic acid, 1,4-cyclohexane dicarboxylic acid, and anhydrides thereof, as well as mixtures thereof. In some embodiments, the polycarboxylic acid may be selected from tricarboxylic acids such as trimellitic acid and anhydrides thereof.

The specific type and amount of reactant used to create the polyester resin may influence the melt viscosity, crystallinity, and Tg of the polymeric resin. Specifically, aromatic and/or cycloaliphatic monomers lead to high Tg polymers, and longer-chain aliphatic monomers lead to lower Tg polymers. For example, a polyester resin having a significant level of ester groups in the backbone that are derived from terephthalic acid/isophthalic acid can have its Tg lowered by replacing certain amounts of the terephthalic acid/isophthalic acid with adipic acid, thereby making the polyester resins more flexible and more likely to flow at a lower temperature. However, substituting too much adipic acid will result in the polyester having a Tg that is too low to be used in powder coating formulations.

The urethane modified polyester may include one or more of the above mentioned hydroxyl-functional polyesters reacted with an isocyanate-functional compound to form the presence of urethane linkages along the polyester backbone. The OH:NCO ratio of polyester to isocyanate-functional compound may be about 1:1 to ensure that all functional groups on both the polyester and the isocyanate-functional compound are consumed during the urethane forming reaction. For the purposes of this invention, the term isocyanate-functional compound may be a polyisocyanate, which refers to compounds having two or more isocyanate functional groups, such as diisocyanate, isocyanurate, biuret, isocyanurate allophanates.

The polyisocyanate of the present invention may be selected from compounds such as isophorone diisocyanate (IPDI), 4,4′-dicyclohexylmethane-diisocyanate, and trimethyl-hexamethylene-diisocyanate, 1,6-hexamethylene diisocyanate, 2,2,4-trimethylhexamethylene diisocyanate, octadecylene diisocyanate and 1,4 cyclohexylene diisocyanate. toluene diisocyanate; methylenediphenyl diisocyanate; tetra methylxylene diisocyanate, and isocyanurates, biurets, allophanates thereof, as well as mixtures thereof, as well as adducts, isocyanurates, biurets, and allophanates thereof. In one embodiment, the polyisocyanate comprises IPDI.

The base coat layer 300 may be formed of a base coat composition. The base coat composition may be substantially free of chromium. In some embodiments, the base coat composition may be free of chromium—i.e., the base coat composition has a content of chromium that is 0.0 wt. % based on the total weight of the base coat composition. The base coat layer 300 may be formed of 100 wt. % of the base coat composition based on the total weight of the base coat layer 300.

The base coat composition may be substantially free of PVDF. In some embodiments, the base coat composition may be free of PVDF—i.e., the base coat composition has a content of PVDF that is 0.0 wt. % based on the total weight of the base coat composition. The base coat layer 300 may be formed of 100 wt. % of the base coat composition based on the total weight of the base coat layer 300.

The base coat composition of the base coat layer 300 on the coil coating 40 may be in a solid state. The base coat composition of the base coat layer 300 on the coil coating 40 may have a solids content of about 100 wt. % based on the total weight of the base coat composition. The base coat composition of the base coat layer 300 on the coil coating 40 may have a solids content of about 100 wt. % based on the total weight of the base coat layer 300 within the coil coating 40 on the coated article 10.

In some embodiments, the base coat composition may be substantially free of silicon containing compounds. In some embodiments, the base coat composition may be substantially free of silicon. In some embodiments, the base coat composition may be substantially free of colorant. In other embodiments, the base coat composition may comprise colorant (e.g., pigment of titanium dioxide—TiO₂) in an amount ranging from about 1 wt. % to about 5 wt. % based on the total weight of the base coat composition—including all wt. % and sub-ranges there-between.

The base coat composition may comprise a polymer. The polymer may be an organic polymer. The polymer may be one or more of the aforementioned polyester polymers. The polyester polymer may be substantially free of silicon. The polyester polymer may be free of urethane linkages.

In some embodiments, the base coat composition may comprise minor amounts of silicon containing compound that is separate from the polymer, whereby the polymer is free of silicon containing groups. In a non-limiting example, the base coat composition may comprise polyester polymer that is free of both urethane linkages as well as free of silicon-containing groups and the base coat composition may further comprise silica in an amount of 1 wt. % to about 5 wt. % based on the total weight of the base coat composition.

The polymer may be present in the base coat composition in an amount ranging from about 60 wt. % to about 100 wt. % based on the total weight of the base coat composition—including all wt. % and sub-ranges there-between.

The print coat layer 400 may be formed of a print coat composition. The print coat composition may be substantially free of chromium. In some embodiments, the print coat composition may be free of chromium—i.e., the print coat composition has a content of chromium that is 0.0 wt. % based on the total weight of the print coat composition. The print coat layer 400 may be formed of 100 wt. % of the print coat composition based on the total weight of the print coat layer 400.

The print coat composition may be substantially free of PVDF. In some embodiments, the print coat composition may be free of PVDF—i.e., the print coat composition has a content of PVDF that is 0.0 wt. % based on the total weight of the print coat composition. The print coat layer 400 may be formed of 100 wt. % of the print coat composition based on the total weight of the print coat layer 400.

The print coat composition of the print coat layer 400 on the coil coating 40 may be in a solid state. The print coat composition of the print coat layer 400 on the coil coating 40 may have a solids content of about 100 wt. % based on the total weight of the print coat composition. The print coat composition of the print coat layer 400 on the coil coating 40 may have a solids content of about 100 wt. % based on the total weight of the print coat layer 400 within the coil coating 40 on the coated article 10.

In some embodiments, the print coat composition may be substantially free of silica. The print coat composition may comprise one or more colorants. Non-limiting examples of colorant include pigment, dyes, and combinations thereof. Non-limiting examples of pigments include titanium dioxide (TiO2), titanium dioxide-coated mica, iron oxide-coated mica, mixed oxide-coated mica (with titanium dioxide and Fe₂O₃, for example), metal oxide-coated aluminum, azo pigments, phthalocyanine pigments, quinacridone pigments, and pyrrolopyrrole pigments, carbon black. Non-limiting examples of dyes include azo, azine, anthraquinone, acridine, cyanine, oxazine, polymethine, thiazine and triarylmethane dyes.

The colorant may be present in the print coat composition in the solid-state in an amount ranging from about 1 wt. % to about 50 wt. % based on the total weight of the print coat composition—including all wt. % and sub-ranges there-between—in the solid-state.

The colorant present in the print coat composition may impart a visual design to the resulting coil coating 40. The visual design resulting from the print coat composition of the print layer 400 may be apparent from an observer when viewing the upper surface 41 of the coil coating 40. The visual design resulting from the print coat composition of the print layer 400 may be apparent from an observer when viewing the first major exposed surface 11 of the coated article 10.

The print coat composition may comprise a polymer. The polymer may be an organic polymer. The polymer may be one or more of the aforementioned polyester polymers that has been further modified with a silicon-containing group—also referred to as a “siliconized polymer” or “silicon-containing polymer”. In some embodiments, the polyester polymer may be free of urethane linkages.

The term silicon-containing polymer or silicon-containing polyester refers to a polymer (or polyester) comprising one or more—SiO—units in the backbone. Such silicon based polymers can include hybrid polymers, such as those comprising organic polymeric blocks (i.e., ester blocks or polyester blocks) with one or more—SiO—units in the backbone. In other embodiments, the term silicon-containing polymer or silicon-containing polyester refers to a polymer (or polyester) comprising one or more—SiO—units in the backbone. Such silicon based polymers can include hybrid polymers, such as those comprising organic polymeric blocks (i.e., ester blocks or polyester blocks) with one or more—SiO—units in the backbone.

The polymer may be present in the print coat composition in an amount ranging from about 50 wt. % to about 98 wt. % based on the total weight of the base coat composition—including all wt. % and sub-ranges there-between. In a non-limiting example, the print coat composition may comprise siliconized polyester polymer that is free of both urethane linkages and the print coat composition may further be substantially free of silica. The remainder of the print coat may comprise of additive to control viscosity and wetting.

The top coat layer 500 may be formed of a top coat composition. The top coat composition may be substantially free of chromium. In some embodiments, the top coat composition may be free of chromium—i.e., the top coat composition has a content of chromium that is 0.0 wt. % based on the total weight of the top coat composition. The top coat layer 500 may be formed of 100 wt. % of the top coat composition based on the total weight of the top coat layer 500.

The top coat composition may be substantially free of PVDF. In some embodiments, the top coat composition may be free of PVDF—i.e., the top coat composition has a content of PVDF that is 0.0 wt. % based on the total weight of the top coat composition. The top coat composition may be substantially free of colorant. In some embodiments, the top coat composition may be free of colorant—i.e., the top coat composition has a content of colorant that is 0.0 wt. % based on the total weight of the top coat composition. The top coat layer 500 may be formed of 100 wt. % of the top coat composition based on the total weight of the top coat layer 500.

The top coat composition of the top coat layer 500 on the coil coating 40 may be in a solid state. The top coat composition of the top coat layer 500 on the coil coating 40 may have a solids content of about 100 wt. % based on the total weight of the top coat composition. The top coat composition of the top coat layer 500 on the coil coating 40 may have a solids content of about 100 wt. % based on the total weight of the top coat layer 500 within the coil coating 40 on the coated article 10.

In some embodiments, the top coat composition may comprise silica. The silica may be present in the top coat composition in the solid-state in an amount ranging from about 0.1 wt. % to about 10 wt. % based on the total weight of the top coat composition—including all wt. % and sub-ranges there-between—in the solid-state.

The top coat composition may comprise a polymer. The polymer may be an organic polymer. The polymer may be one or more of the aforementioned polyester polymers that has been further modified with a silicon-containing group. In some embodiments, the polyester polymer of the top coat composition may be free of urethane linkages.

The polymer may be present in the top coat composition in an amount ranging from about 85 wt. % to about 99.9 wt. % based on the total weight of the top coat composition—including all wt. % and sub-ranges there-between. In a non-limiting example, the top coat composition may comprise siliconized polyester polymer that is free of both urethane linkages and the top coat composition may further be substantially free of colorant.

The resulting top coat layer 500 may be substantially transparent. In some embodiments, the resulting top coat layer 500 may be transparent. The transparent nature of the top coat layer 500 may allow for the visual design of the print coat layer 400 to readily show through, thereby allowing such visual design to be apparent without any distortion or concealment when viewing from the upper surface 41 of the coil coating 40.

It has been surprisingly discovered that the combination of the combination of the base coat layer 300, the print coat layer 400, and the top coat layer 500 results in a coil coating 40 that exhibits not only superior printability of the visual design, but also unexpectedly exhibits a marked improvement in mechanical integrity by having superior bending strength without cracking or other failure. The improvement in both aesthetics (i.e., visual design) as well as mechanical strength (i.e., superior bendability) is also achieved while the coating is free of chromium, PVDF, as well as low levels of formaldehyde (<9 μg/m³).

The substrate 100 may be formed of a metal. Non-limiting examples of metal include steel, aluminum, and tin.

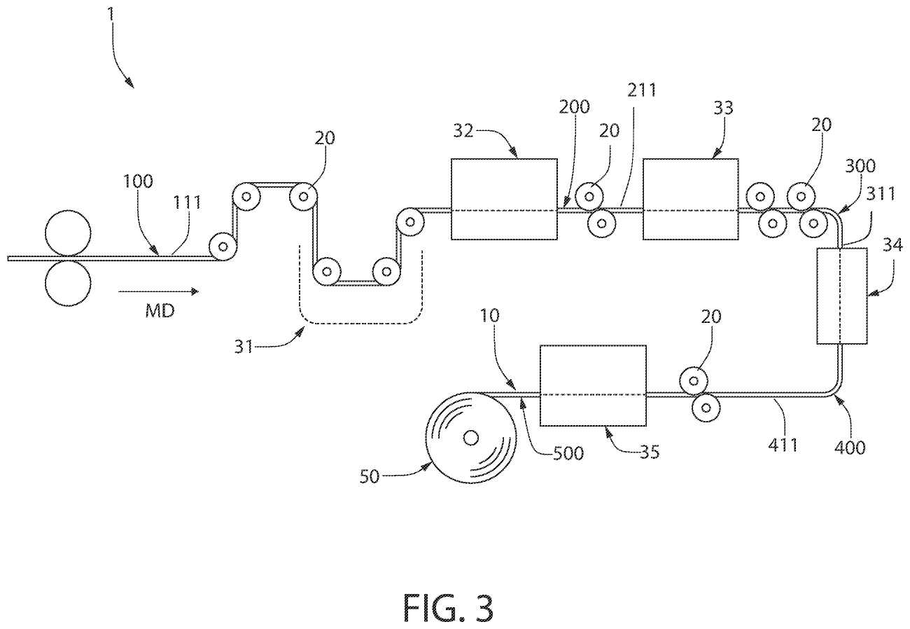

Referring now to FIG. 3, a method and system 1 of manufacturing the coated article 10 is shown. The system 1 includes a first coating zone 32, a second coating zone 33, a third coating zone 34, and a fourth coating zone 35. The system 1 further comprises a plurality of guiding elements 20 that guide a workpiece through each coating zone—non-limiting example of guiding elements 20 include rollers. Each of the first coating zone 32, second coating zone 33, third coating zone 34, and fourth coating zone 35 may comprise a coating applier as well as a coating dryer.

In a first stage, the method of forming the coated article 10 may comprises feeding the substrate 100 along a machine direction (“MD”) thereby passing through a plurality of guiding elements 20. The substrate 100 may enter the first coating zone 32, whereby the primer coat composition in a wet-state (also referred to as a “wet-state primer coat composition”) is applied to the upper surface 111 of the substrate 100. The “wet-state” refers to the reference composition further comprising a liquid-carrier. The wet-state primer coat composition may be applied by curtain coating.

Non-limiting examples of liquid carrier include water, xylene, alcohol (isopropanol, diacetone alcohol), and propylene glycol methyl ether acetate).

The wet-state primer coat composition may comprise liquid carrier in an amount ranging from about 48 wt. % to about 57 wt. % based on the total weight of the wet-state primer coating composition—including all wt. % and sub-ranges there-between.

Subsequently, the wet-state primer coat composition that is applied to the substrate 100 may be dried. Drying of the wet-state primer coating composition may occur within the first coating zone 32 through the use of one or more heating elements. In other embodiments, the wet-state primer coating composition may be dried outside of the first coating zone 32 before reaching the second coating zone 33. Drying the wet-state primer coat composition results in the liquid carrier of the wet-state primer coating composition being evaporated, thereby resulting in a primer coating layer 200 in the solid-state. The drying of the wet-state primer coat composition may occur at an elevated temperature ranging from about 100° C. to about 300° C.—including all temperatures and sub-ranges there-between.

In a second stage, the workpiece may continue to be fed along the machine direction (“MD”) and through a plurality of guiding elements 20. The substrate 100 coated with the primer coat layer 200 may enter the second coating zone 33, whereby the base coat composition in a wet-state is applied to the upper surface 211 of prime coat layer. The wet-state base coat composition may be applied by curtain coating.

The wet-state base coating composition may comprise liquid carrier in an amount ranging from about 45 wt. % to about 55 wt. % based on the total weight of the wet-state base coating composition.

Subsequently, the wet-state base coat composition may be dried. Drying of the wet-state base coating composition may occur within the second coating zone 33 through the use of one or more heating elements. In other embodiments, the wet-state base coating composition may be dried outside of the second coating zone 33 before reaching the third coating zone 34. Drying the wet-state base coat composition results in the liquid carrier of the wet-state base coating composition being evaporated, thereby resulting in a base coating layer 300 in the solid-state. The drying of the wet-state base coat composition may occur at an elevated temperature ranging from about 100° C. to about 300° C.—including all temperatures and sub-ranges there-between.

In a third stage, the workpiece may continue to be fed along the machine direction (“MD”) and through a plurality of guiding elements 20. The substrate 100 coated with the primer coat layer 200 and the base coat layer 300 may enter the third coating zone 34, whereby the print coat composition in a wet-state is applied to the upper surface 311 of base coat layer 300. The wet-state print coat composition may be applied by rotogravure printing.

The wet-state print coat composition may comprise liquid carrier in an amount ranging from about 39 wt. % to about 43 wt. % based on the total weight of the wet-state print coat composition—including all wt. % and sub-ranges there-between.

Subsequently, the wet-state print coat composition may be dried. Drying of the wet-state print coating composition may occur within the third coating zone 34 through the use of one or more heating elements. In other embodiments, the wet-state print coating composition may be dried outside of the third coating zone 34 before reaching the fourth coating zone 35. Drying the wet-state print coat composition results in the liquid carrier of the wet-state print coating composition being evaporated, thereby resulting in a print coating layer 400 in the solid-state. The drying of the wet-state print coat composition may occur at an elevated temperature ranging from about 100° C. to about 300° C.—including all temperatures and sub-ranges there-between.

In a fourth stage, the workpiece may continue to be fed along the machine direction (“MD”) and through a plurality of guiding elements 20. The substrate 100 coated with the primer coat layer 200, the base coat layer 300, and the print coat layer 400 may enter the fourth coating zone 35, whereby the top coat composition in a wet-state is applied to the upper surface 411 of print coat layer 400. The wet-state top coat composition may be applied by curtain coating.

The wet-state top coat composition may comprise liquid carrier in an amount ranging from about 40 wt. % to about 45 wt. % based on the total weight of the wet-state top coat composition—including all wt. % and sub-ranges there-between.

Subsequently, the wet-state top coat composition may be dried. Drying of the wet-state print coating composition may occur within the fourth coating zone 35 through the use of one or more heating elements. In other embodiments, the wet-state top coat composition may be dried outside of the fourth coating zone 35 before reaching a roll element 50. Drying the wet-state top coat composition results in the liquid carrier of the wet-state top coat composition being evaporated, thereby resulting in a top coat layer 500 in the solid-state. The drying of the wet-state top coat composition may occur at an elevated temperature ranging from about 100° C. to about 300° C.—including all temperatures and sub-ranges there-between.

In a fifth stage, the coated article 10 may continue along the machine direction (MD) and be wound into a coil within a rolling element 50, whereby the wound coated article 10 may be stored, shipped, etc.

In some embodiments, the system 1 may further comprise a pretreatment zone 31. The pretreatment zone 31 may be located along the machine direction (MD) before the first coating zone 32. The pretreatment zone 31 may include application of a pretreatment solution to the substrate 100 to prepare the substrate for the primer coat composition. The pretreatment solution may clean the upper surface 111 of the substrate 100 to remove any impurities that may detrimentally effect the adhesion of the coil coating 40 to the substrate 100.

The following examples are prepared in accordance with the present invention. The present invention is not limited to the examples described herein.

### Examples

The following experiments were conducted to demonstrate the unexpected improvement in both printability and mechanical strength of the coil coating of the present invention. A number of coil coatings were prepared and applied to identical ones of a metal substrate. The differences in each coil coating is set forth below in Table 1.

The resulting performance for each building panel is set forth below in Table 1.

TABLE 1

| Comp. | Comp. | Comp. | Ex. |
|---|---|---|---|
| Ex. 1 | Ex. 2 | Ex. 3 | 1 |

Primer Coat

| | | | | |
|---|---|---|---|---|
| Urethane-Modified Polyester^{1, 2} | Y | Y | N | Y |
| PVDF Primer | N | N | Y | N |

Base Coat

| | | | | |
|---|---|---|---|---|
| Siliconized Polyester² | Y | N | N | N |
| Non-Siliconized Polyester² | N | Y | N | Y |
| PVDF | N | N | Y | N |

Print Coat

| | | | | |
|---|---|---|---|---|
| Siliconized Polyester² | Y | N | N | Y |
| Non-Siliconized Polyester² | N | Y | N | N |
| PVDF | N | N | Y | N |
| Pigment | Y | Y | Y | Y |

Top Coat

| | | | | |
|---|---|---|---|---|
| Siliconized Polyester² | Y | N | N | Y |
| Non-Siliconized Polyester² | N | Y | N | N |
| PVDF | N | N | Y | N |
| Silica | Y | Y | Y | Y |

Performance Tests

| | | | | |
|---|---|---|---|---|
| Coating Bending Test @ 20-22° C. | Fail | Fail | Fail | Pass |
| Printability | Fail | Pass | Pass | Pass |

Superscript¹ refers to the composition being Chromium-free.
Superscript² refers to the composition being formaldehyde-free (emission testing results in a formaldehyde content of <9 μg/m³).

The bending test was performed according to ASTM D4145 standard. Printability test was performed by visually assessing each sample and determining whether the sample met a commercially acceptable threshold for aesthetic appearance. A failing grade results from a non-commercially viable appearance while the passing grade results from a commercially viable appearance.

As demonstrated by Table 1, the coil coating composition according to Ex. 1 exhibited a passing grade in both of the bending and printability test while also being free of chromium and formaldehyde. Most surprisingly is that the difference between Comp. Ex. 1 and Ex. 1 is the absence of the siliconized polymer in the base coat (Ex. 1) whereby the presence of such siliconized polyester (Comp. Ex. 1) resulted in failing grades for both bending and printability.

What is claimed is:

1. A coated article comprising
a substrate;
a coil coating applied to the substrate, the coil coating comprising:
a base coat layer formed from a base coat composition comprising polyester that is substantially free of silicon;
a print coat layer formed from a print coat composition comprising siliconized polyester; and
a top coat layer formed from a top coat composition comprising siliconized polyester.

2. The coated article according to claim 1 further comprising a primer coat layer located between the substrate and the base coat, the primer coat layer being substantially free of chromium.

3. The coated article according to claim 2, wherein the primer coat composition comprises urethane modified polyester.

4. The coated article according to claim 1, wherein the polyester of the base coat layer is present in an amount ranging from about 60 wt. % to about 100 wt. %, based on the total weight of the base coat composition.

5. The coated article according to claim 1, wherein the print coat composition comprises colorant present in an amount ranging from about 1 wt. % to about 50 wt. %, based on the total weight of the print coat composition.

6. The coated article according to claim 1, wherein the siliconized polyester of the print coat layer is present in an amount ranging from about 50 wt. % to about 98 wt. %, based on the total weight of the print coat composition.

7. The coated article according to claim 1, wherein the top coat composition comprises silica.

8. The coated article according to claim 1, wherein the silica of the top coat composition is present in an amount ranging from about 0.1 wt. % to about 10 wt. %, based on the total weight of the top coat composition.

9. The coated article according to claim 1, wherein the siliconized polyester of the top coat layer is present in an amount ranging from about 85 wt. % to about 99.9 wt. %, based on the total weight of the top coat composition.

10. The coated article according to claim 1, wherein the substrate is formed of a metal.

11. A coated article comprising a first major exposed surface opposite a second major exposed surface, the coated article comprising:
a substrate comprising an upper surface opposite a lower surface;
a coil coating applied to the substrate, the coil coating having an upper surface opposite a lower surface and the coil coating comprising:
a primer coat layer comprising an upper surface opposite a lower surface, the primer layer formed from a primer composition that is substantially free of chromium;
a base coat layer comprising an upper surface opposite a lower surface, the base coat layer formed from a base coat composition comprising polyester that is substantially free of silicon;
a print coat layer comprising an upper surface opposite a lower surface, the print coat layer formed from a print coat composition comprising siliconized polyester; and
a top coat layer comprising an upper surface opposite a lower surface, the top coat layer formed from atop coat composition comprising siliconized polyester; and
wherein the first major exposed surface of the coated article comprises the upper surface of the top coat layer.

12. The coated article according to claim 11, wherein the primer coat composition comprises urethane modified polyester that is substantially free of silicon

13. The coated article according to claim 11, wherein the print coat composition comprises colorant.

14. The coated article according to claim 11, wherein the top coat composition comprises silica.

15. The coated article according to claim 11, wherein the topcoat layer is substantially transparent.

16. The coated article according to claim 11, wherein the substrate is formed of a metal.

17. A method of forming a coated article comprising:
a) applying a wet-state primer coating composition comprising a liquid carrier to a substrate and drying the wet-state primer coating composition that is applied to the substrate such that the liquid carrier of the wet-state primer coating composition is evaporated resulting in a primer coating layer;
b) applying a wet-state base coating composition comprising a liquid carrier to the primer coating layer and drying the wet-state base coating composition that is applied to the primer coating layer such that the liquid carrier of the wet-state base coating composition is evaporated resulting in a base coating layer;
c) applying a wet-state print coating composition comprising a liquid carrier to the base coating layer and drying the wet-state print coating composition that is applied to the base coating layer such that the liquid carrier of the wet-state print coating composition is evaporated resulting in a print coating layer;
d) applying a wet-state top coating composition comprising a liquid carrier to the print coating layer and drying the wet-state top coating composition that is applied to the print coating layer such that the liquid carrier of the wet-state top coating composition is evaporated resulting in a top coating layer; and
wherein the wet-state base coating composition further comprises an organic polymer that is substantially free of silicon;
wherein the wet-state print coating composition further comprises siliconized organic polymer; and
wherein the wet-state top coating composition further comprises siliconized organic polymer.

18. The method according to claim 17, wherein subsequent to step d), the substrate coated with primer coat layer, the base coat layer, the print coat layer, and the top coat layer is rolled into a coil.

19. The method according to claim 17, wherein:
the application of the wet-state primer coat composition in step a) is performed by curtain coating;
the application of the wet-state base coat composition in step b) is performed by curtain coating;
the application of the wet-state primer coat composition in step c) is performed by rotogravure printing; and
the application of the wet-state top coat composition in step d) is performed by curtain coating.

20. The method according to claim 17, wherein the liquid carrier of the wet-state primer coat composition is evaporated in:
step a) at an elevated temperature ranging from about 100° C. to about 300° C.;
step b) at an elevated temperature ranging from about 100° C. to about 300° C.;
step c) at an elevated temperature ranging from about 100° C. to about 300° C.; and
step d) at an elevated temperature ranging from about 100° C. to about 300° C.
